(19) United States
(12) Patent Application Publication
(10) Pub. No.: US 2010/0015825 A1
(43) Pub. Date: Jan. 21, 2010

(54) Retractable Connector for an Electronic Device

(76) Inventor: Frank J. ZIBERNA, Winfield, IL (US)

Correspondence Address: Erickson Law Group, PC, 1749 S. NAPERVILLE ROAD, SUITE 202, WHEATON, IL, 60189, US

(21) Appl. No.: 12/388,408

(22) Filed: Feb. 18, 2009

Related U.S. Application Data
(60) Provisional application No. 61/082,084, filed on Jul. 18, 2008.

(51) Int. Cl. H01R 13/44

(52) U.S. Cl. 439/131; 439/135

(57) ABSTRACT

A retractable connector device having an inner housing, a cover belt, and two sidewalls. The device may comprise electronic components for electronic devices including computer peripheral devices such as serial bus devices, Universal Serial Bus (USB) devices, or IEEE 1394 devices. The belt surrounds a portion of the inner housing. The belt is for moving the device between at least two positions, a deployed position where the connector extends through a hole in the inner housing to connect to a receiving device, and a stored position where the connector is within the housing, separated and protected from external elements by, at least in part, the belt.

This application claims the benefit of U.S. Provisional Ser. No. 61/082,084, filed on Jul. 18, 2008.

### TECHNICAL FIELD OF THE INVENTION

The invention relates to the field of connectors for electronic devices, specifically connectors that are retractable when not in use.

### BACKGROUND OF THE INVENTION

Many electronic devices have connectors for connecting to another device or receiver. Serial bus devices, Universal Serial Bus (USB) devices, or IEEE 1394 devices all connect to computers or other electronic devices with a connector. Many such devices are portable. These devices may be exposed to various elements and forces that may damage the connector, when for example, a user transports the device. Many connector devices have a removable cap for protecting the connector when not in use. However, the cap is easily misplaced.

The present inventor recognizes that it would be desirable to provide a connector housing for electronic devices, such as USB devices, that would protect the connector when the connector is not engaged with a receiving device. The present inventor recognizes a need for a device that is easily used by persons with dexterity difficulty. The present inventor recognizes a need for a means of protecting a connector that is a unified component of the device even when the connector is engaged with a receiving device.

### SUMMARY OF THE INVENTION

The invention provides a retractable connector device having a connector and a housing for protecting the connector. The housing comprises an inner housing, a belt, and two sidewalls. The device has at least two positions, a deployed position where the connector is in position to connect to a receiver and/or receiving device, and a stored position where the connector is separated and protected from external elements by the belt. A user moves the device between the deployed and stored positions by moving the belt. A user may move the belt using a thumb plate attached to the belt.

When the device is in a stored position the belt covers a hole in the front of the inner housing. When the device is in a deployed position, the belt is clear of the hole and the connector passes through the hole to extend beyond the housing and is in a position to connect to a receiving device.

In operation, to move from stored position, a user will move the thumb plate toward the rear of the device to move the device toward the deployed position. In doing so, the belt is raised up the front face to clear the hole and the belt moves along the top surface of the inner housing. The belt wraps around the back end of the inner housing and continues on the bottom of the device toward the front of the device on a first bottom portion of the inner housing. The belt travels in a gap on the bottom of the inner housing between the first bottom portion and a second bottom portion. The gap is where the belt enters a cutout area of the inner housing and attaches to a connector mount of the connector.

When moving to the stored position from the deployed position, if the belt front edge is on the top portion of the inner housing it will move toward the front of the housing. The belt front edge will curve around the inner housing front upper surface, continuing down the front face to cover the hole and protect the connector.

The device may comprise electronic components for electronic devices including computer peripheral devices such as serial bus devices, Universal Serial Bus (USB) devices, or IEEE 1394 devices. A connector front surface of the connector may comprise any connector appropriate for a particular type of electronic device comprising a particular embodiment of the device. The device may comprise a storage device such as a hard disk drive (HDD), a solid-state drive (SSD), a flash drive, or a flash media card receiver. The device 100 may be used in any application where it would be desirable to cover or protect a signal connector when the connector is not connected to a receiving component or device.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a right side perspective view of the retractable connector device of the present invention in a deployed position;

FIG. 2 is a right side perspective view of the retractable connector device in a stored position with the right sidewall removed;

FIG. 3 is a left side perspective view of the retractable connector device in a stored position with the left sidewall removed;

FIG. 4 is a right side perspective view of the retractable connector device with the right sidewall removed and showing the device in a position between a fully stored position and a fully deployed position;

FIG. 5 is a right side perspective view of the retractable connector device with the right sidewall removed and showing the device in a fully deployed position;

FIG. 6 is a right side perspective view of the retractable connector device with the right sidewall removed and showing the device in a position between a fully stored position and a fully deployed position; and

FIG. 7 is a left sidewall of the retractable connector device.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

### The Overall System

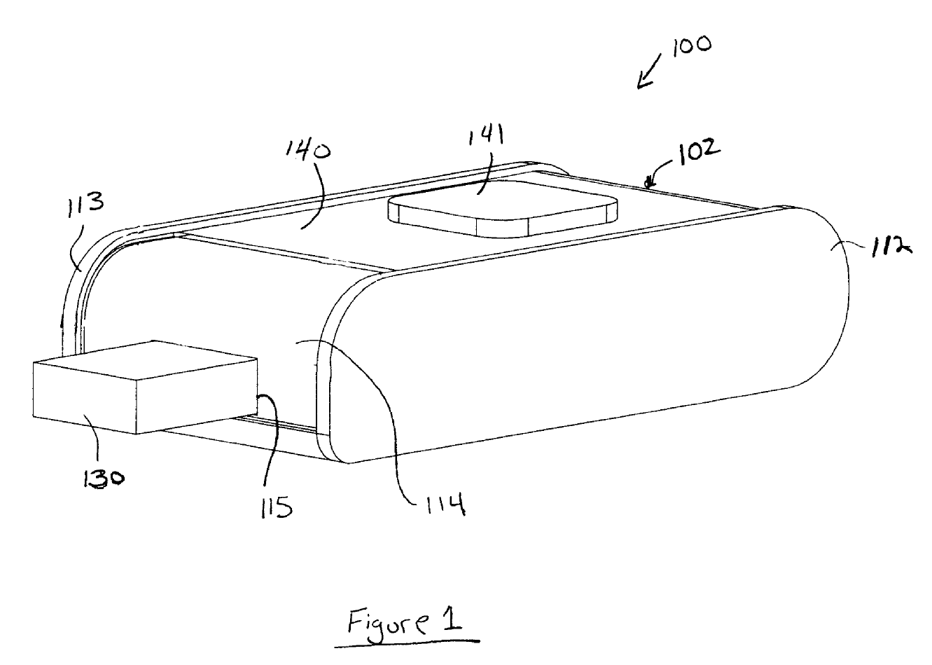

FIG. 1 shows a retractable connector device 100 comprising a housing 120. The housing comprises a right sidewall 112, a left sidewall 113, and an inner housing 114. The connector device 100 also comprises a connector 130 and a cover belt 140 with a thumb plate 141.

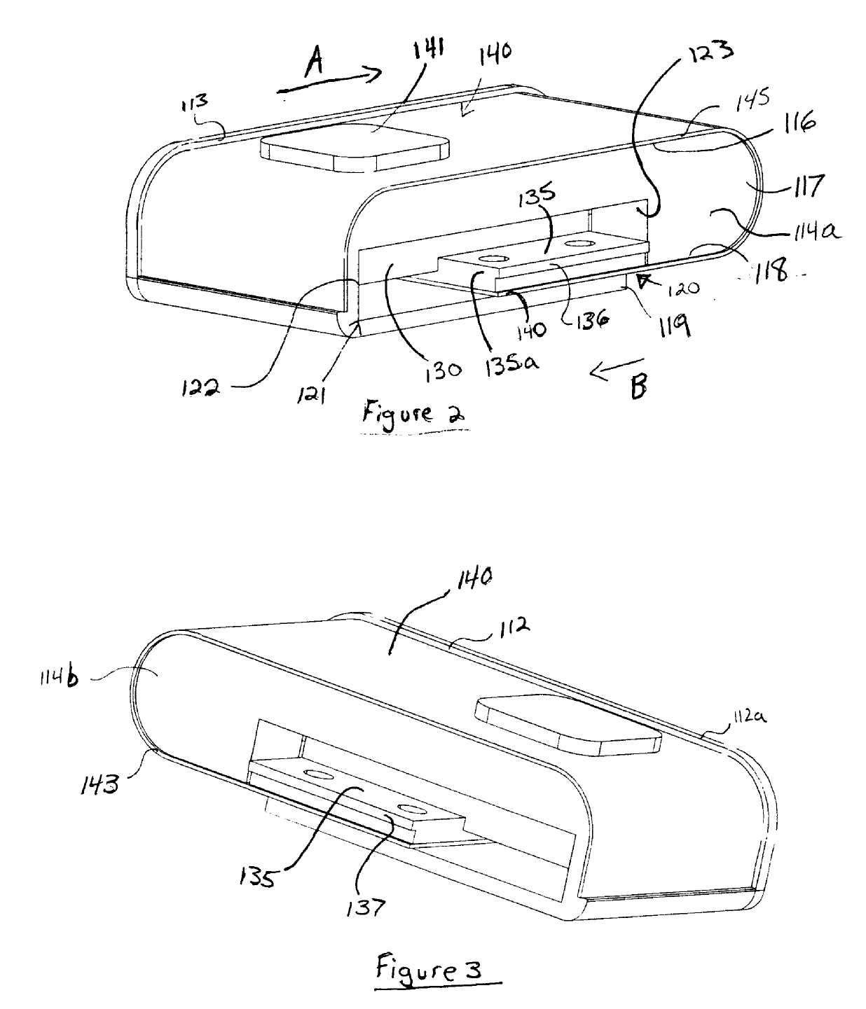

The connector device 100 has an deployed position as shown in FIG. 1 where the connector 130 extends through a hole 115 in the front of the inner housing 114. The connector device 100 also has a stored position, as shown in FIG. 2, where the connector is retracted within the device 100. The connector 130 has an extended position corresponding to the deployed position of the device 100, and the connector 130 has a retracted position corresponding to the stored position of the device. In operation, movement of the belt 140 will cause the connector 130 to move between the retracted position (FIG. 2) where the connector is separated and protected from external elements by the belt, and the extended position (FIG. 1) where the connector is in position to connect to a receiver or a receiving device.

### Belt

The belt 140 is connected to the connector 130 by a connector mount 135 near a bottom portion of the inner housing. The belt may comprise flexible plastic, rubber, or composite material. The thumb plate 141 is connected to the belt 140 on a top side of the housing when the device is in a stored position. The belt is flexible and is guided to travel along a partially curved track during operation. In operation, a user will move the thumb plate in the A direction as shown in FIG. 2 to cause the device 100 to move toward the deployed position. This will cause the belt 140 on the top portion 116 of the inner housing 114 to move in the A direction. The belt 140 will wrap around the back end 117 of the inner housing 114 and continue in the B direction on the first bottom portion 118 of the inner housing 114. The belt travels in a gap 120 on the bottom of the inner housing 114 between the first bottom portion 118 and the second bottom portion 119. The belt 140 travels on the bottom side of the first bottom portion 118 and the belt 140 travels on the top side of the second bottom portion 119.

### Inner Housing

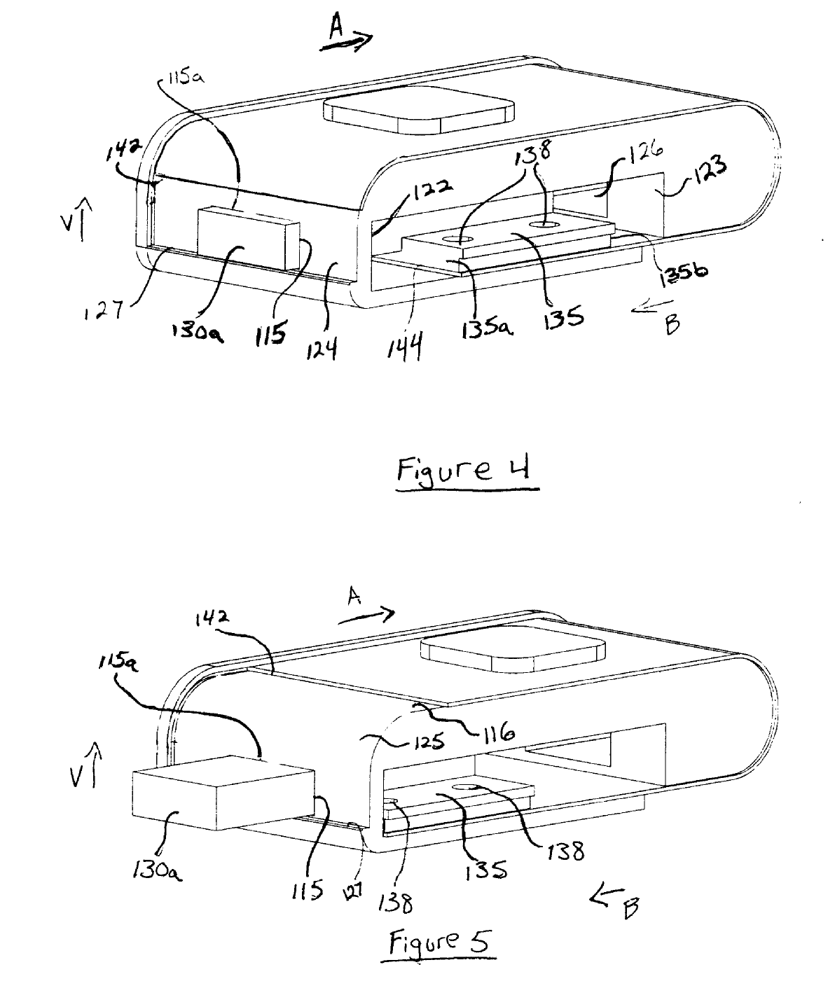

The inner housing 114 comprises a cutout area 121 (FIG. 2). The cutout area 121 has a front wall 122 and a back wall 123. Referring to FIG. 4, as the belt 140 moves the connector 130 from the retracted position (FIG. 2) to the extended position (FIG. 1), the belt moves up the front face 124 of the inner housing 114. This causes the belt front edge 142 to raise in the V direction with the belt 114 and curve around the inner housing front upper surface 125 (FIG. 5), continuing in the A direction. The belt travel continues until the connector mount front surface 135a, traveling in the B direction, meets the front wall 122 of the inner housing 114 as shown in FIG. 5.

When moving the connector to the retracted position from the extended position, if the belt front edge 142 is on the top portion 116 it will move in the direction opposite the A direction. The belt front edge 142 will curve around the inner housing front upper surface 125 (FIG. 5), continuing down the front face 124 in the direction opposite of the V direction to cover the hole 115. In one embodiment, the belt front edge will continue in the direction opposite of the V direction until the belt front edge 142 meets the inner housing front lip 127. The belt 140 rides on a belt riding surface of the inner housing 141. The belt riding surface extends from the inner housing front lip 127 up the front face 124, across the top portion 116, around the end portion of the inner housing opposite the front face 124, and along a bottom portion of the inner housing before the gap 120 and closer to the end portion opposite the front face 124.

When the connector mount front surface 135a meets the front wall 122 the connector 135 is in a fully extended position, as shown in FIG. 5. In the fully extended position, the belt front edge 142 is on the top portion 116 of the inner housing 114. However, in another embodiment, the belt front edge 142 may be at any position clear of the hole 115. In the fully retracted position, the connector mount rear surface meets the rear wall 123.

In another embodiment, the connector mount 135 need not meet the back wall 123 in a retracted position, nor the front wall 122 in an extended position. In this type of embodiment, the connector mount 135 may be at any position within the cutout area 121, between the front wall 122 and the back wall 123, when in a retracted position as long as a connector front surface 130a is behind the plane defined by the front face 124 of the inner housing 114. When moving from a extended position to a retracted position, the belt will travel properly on the inner housing 114 as long as the connector front surface 130a is behind the plane defined by the front face 124 before the belt front edge 142 meets the top edge 115a of the hole 115 when the belt is moving opposite the V direction (FIG. 4).

In another embodiment, the connector mount 135 need not meet the front wall 122 in an extended position. In this embodiment, connector mount 135 may be at any position within the cutout area 121, between the front wall 122 and the back wall 123, when in an extended position as long as the connector 130 extends beyond the plane defined by the front face 124 a sufficient length for the connector to engage a receiver or a receiving device. Also in this embodiment, the front connector front surface 130a must not break the plane defined by front face 124 before the belt front edge 142 clears the top edge 115a of the hole 115.

### Side Walls

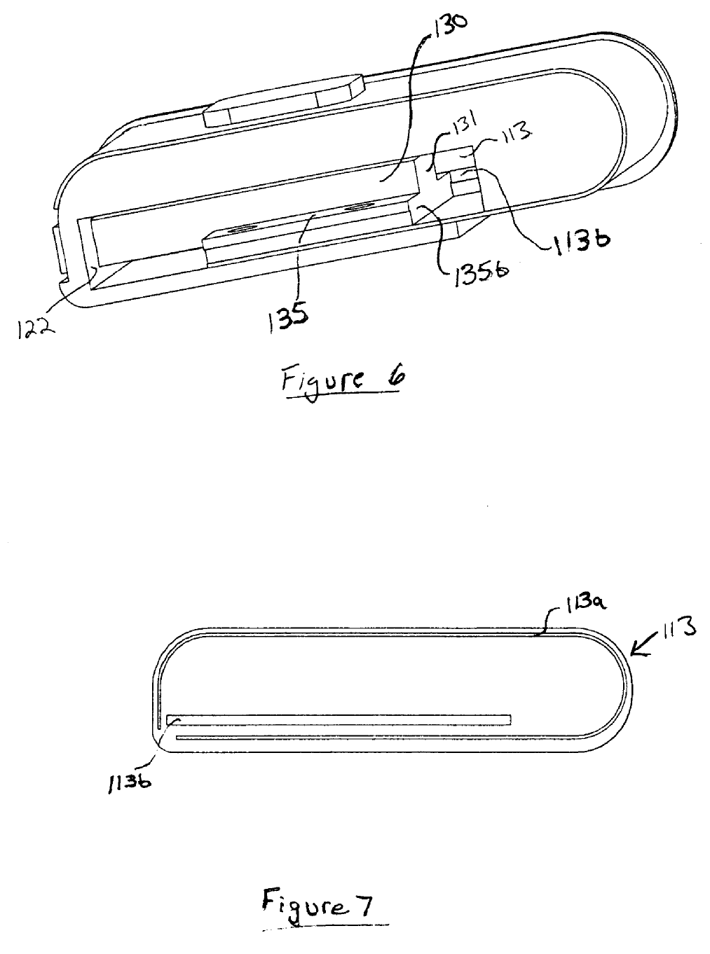

The left sidewall 113 connects to the inner housing left side 114b (FIG. 3) and the right sidewall 112 connects to the inner housing right side 114a (FIG. 2). The sidewalls 112, 113 are configured in mirror image fashion. FIG. 7 shows the left sidewall 113 comprising a belt groove 113a around at least a portion of the sidewall perimeter. The sidewall 113 also comprises a connector mount groove 113b extending horizontally along a lower portion of the sidewall. In another embodiment, the belt groove and the connector mount groove may be located on any portion of the sidewall that allows the connector 130 and the belt 140 to travel so that the device 100 functions to provide the connector 130 in an extended position and a retracted position.

In one embodiment, the left sidewall 113 may mount flush against the inner housing left side 114b and the right sidewall 112 may mount flush against the inner housing right side 114a. In this embodiment, the belt right edge 145 (FIG. 2) may extend beyond the vertical plane defined by the inner housing right side 114a, and the belt left edge 143 (FIG. 3) may extend beyond the vertical plane defined by the inner housing left side 114b. Therefore, the belt right edge 145 will extend into the belt groove (not shown) of the right sidewall 112, and belt left edge 143 will extend into the belt groove 113a (FIG. 7) of the right sidewall 113. The belt 140 travels within the belt grooves 113a of the sidewalls.

In one embodiment, the top surface of the belt 140 may be recessed from the sidewall top surface 112a (FIG. 3). In another embodiment, the top surface of the belt may be flush with the top surface of the sidewall.

### Connector

The connector 130 comprises the connector mount 135. The connector 130 and the connector mount 135 may be made from one piece of material or may be separate components connected with a fastener (not shown).

The device 100 and specifically the connector 130 may comprise electronic components for electronic devices including computer peripheral devices such as serial bus devices, Universal Serial Bus (USB) devices, or IEEE 1394 devices. The connector front surface 130a may comprise a USB connector or an IEEE 1394 connector. The connector front surface may comprise any connector appropriate for a particular type of electronic device comprising a particular embodiment of the device 100. The device 100 may comprise a storage device such as a hard disk drive (HDD), a solid-state drive (SSD), a flash drive, or a flash media card receiver. A cord (not shown) may extend from the device 100 for connecting to other components. The device 100 may be used in any application where it would be desirable to cover or protect a signal connector when the connector is not connected to a receiving component or device.

The connector mount 135 comprises mount ridges 136, 137 (FIGS. 2 and 3). In one embodiment, the right mount ridge 136 (FIG. 2) may extend beyond the plane defined by inner housing right side 114a, and the left mount ridge 137 (FIG. 3) may extend beyond the plane defined by the inner housing left side 114b. Therefore, the right mount ridge 136 will extend into the connector mount groove (not shown) of the right sidewall 112, and left mount ridge 137 will extend into the connector mount groove 113b (FIG. 7) of the right sidewall 113. The connector mount 135 travels within the connector mount grooves of the sidewalls 113, 112.

A portion of the belt 140 near the back edge 144 is connected to the connector mount 135. In one embodiment the connector mount 135 may be attached to the belt 140 with screws, bolts, or rivets 138 (FIGS. 4 and 5). In one embodiment, the connector mount 135 may be connected to the belt so that the connector mount front surface 135a is within the same plane as the back end/edge 144 of the belt 140. In another embodiment the connector mount front surface 135a need not be within the same plane as the back end/edge 144 of the belt 140.

FIG. 6 shows that the connector mount rear surface 135b is flush with the connector rear surface 131. In another embodiment, the connector rear surface 131 may extend beyond the plane defined by the connector mount rear surface 135b. FIG. 4 shows a rear hole 126 in the back wall 123 of the cutout area 121. If the connector rear surface 131 extends beyond the plane defined by the connector mount rear surface 135b, then the rear hole 126 can receive a portion of the connector 130 that extends beyond the plane defined by the connector mount rear surface 135b.

From the foregoing, it will be observed that numerous variations and modifications may be effected without departing from the spirit and scope of the invention. It is to be understood that no limitation with respect to the specific apparatus illustrated herein is intended or should be inferred.

I claim:

1. A retractable connector device comprising:
a belt covering a portion of an inner housing;
a connector at least partially within the inner housing and for connecting to an external receiver; and
the belt for moving the connector between a retracted position and an extended position.

2. The retractable connector device of claim 1, wherein the belt at least partially encloses the connector within the inner housing when the connector is in the retracted position.

3. The retractable connector device of claim 1, wherein the belt comprises a thumb plate connected to the belt for moving the belt.

4. The retractable connector device of claim 1, wherein the housing comprises a hole for passing a connecting-end portion of the connector from a position within the inner housing when the connector is in the retracted position to a position beyond the inner housing when the connector is in the extended position, the connecting-end portion of the connector for connecting to an external receiver.

5. The retractable connector device of claim 4, wherein the belt covers the hole when the connector is in the retracted position, and wherein the belt is clear of the hole when the connector is in the extended position.

6. The retractable connector device of claim 1, wherein the belt is connected to the connector and is for moving the connector between the retracted and the extended position.

7. The retractable connector device of claim 1, wherein the inner housing comprises a gap through which a portion of the belt passes from an exterior position on the housing to an interior position within the housing.

8. The retractable connector device of claim 1, wherein the inner housing comprises a cutout area for housing at least a portion of the connector.

9. The retractable connector device of claim 1, wherein the inner housing has a rear hole for receiving a rear portion of the connector when the connector is in a retracted position.

10. The retractable connector device of claim 1, comprising two sidewalls attached to opposite sides of the inner housing.

11. The retractable connector device of claim 10, wherein each sidewall comprises a belt groove around at least a portion of the sidewall perimeter, side edge portions of the belt extend into each belt groove and travel within each belt groove.

12. The retractable connector device of claim 10, wherein each sidewall comprises connector mount grooves extending along a portion of the sidewall; and wherein the connector comprises two mount ridges; the mount ridges travel within the mount grooves to guide the connector.

13. The retractable connector device of claim 1, wherein the inner housing has a belt riding surface on which the belt travels, the belt riding surface extends along more than one side of the inner housing, the transition between one side and the next side along the belt riding surface is curved.

14. The retractable connector device of claim 1, comprising: electronic components connected to the connector.

15. The retractable connector device of claim 14, wherein the electronic components are contained within the inner housing when the connector is in a retracted position.

16. The retractable connector device of claim 1, wherein the belt surrounds a portion of the inner housing.

17. A retractable connector device comprising:
an inner housing for containing a connector, the housing having a hole;
the connector for connecting to an external receiver;
the connector having a retracted position and an extended position;
a first means for moving the connector between the retracted position and the retracted position;
the first means also for covering the hole through which the connector passes when moving from the retracted position to the extended position.

18. The retractable connector device of claim 17, wherein the first means surrounds a portion of the inner housing.

19. The retractable connector device of claim 17, wherein the first means surrounds a portion of the inner housing, and wherein the inner housing comprises a gap through which the first means passes to an interior position within the housing to connect to the connector.

20. A method of protecting a connector device, comprising the steps of
a. providing an inner housing with a hole for passing a connector and a gap for passing a belt from a position inside the inner housing to a position on the exterior of the inner housing, wherein the belt is connected to the connector
b. providing a connector in an extended position
c. moving the belt toward the hole while retracting the connector through the hole into the housing
d. covering the hole with the belt after the connector has recessed passed an opening of the hole.
